(19) United States
(12) Patent Application Publication
(10) Pub. No.: US 2005/0008398 A1
(43) Pub. Date: Jan. 13, 2005

(54) Image forming method and apparatus capable of efficiently replenishing toner from a soft toner container

(76) Inventor: Yoshio Hattori, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/839,136

(22) Filed: May 6, 2004

(30) Foreign Application Priority Data
May 6, 2003 (JP) 2003-128128

(51) Int. Cl. G03G 15/08

(52) U.S. Cl. 399/258

(57) ABSTRACT

An image forming apparatus includes a toner container, a toner transportation tube and a nozzle. The toner container has a connecting cap with an opening having a lateral cross-sectional area through which the toner is discharged. The nozzle has an inner passage having a lateral cross-sectional area greater than sixty percent of the lateral cross-sectional area of the opening and first and second ends arranged opposite in an axial direction. The first and second ends have openings in communication with each other through the inner passage. The first end is connected to the connecting cap of the toner container by insertion of the the connecting cap facing the first end and the second end is connected to the toner transportation tube. The nozzle is arranged in an approximately vertical direction with the first end facing upward.

### CROSS REFERENCE TO RELATED APPLICATIONS

The present application claims priority under 35 U.S.C. § 119 to Japanese Patent Application No. 2003-128128 filed on May 6, 2003 in the Japanese Patent Office, the entire contents of which are incorporated herein by reference.

### BACKGROUND OF THE INVENTION

1. Field of the Invention

The present invention relates to a method and apparatus for image forming, and more particularly relates to a method and apparatus for image forming capable of efficiently replenishing toner from a soft toner container.

2. Discussion of the Background

A background image forming apparatus, such as a copying machine, a facsimile machine, a printing machine and other similar image forming apparatuses, includes a toner container for replenishing fresh toner to the developing unit. When toner contained in the developing unit is consumed due to repeated operations of image forming, the fresh toner is discharged from a toner container, such as a toner bottle, a toner cartridge or other similar toner container packed with fresh toner, and is supplied to the developing unit directly or through a toner hopper.

Conventional containers for dry-type toners are made of high-density polyethylene (HDPE) or other similar resin to form hard bottles which are rigid and have stable shapes. One background toner container has an agitator arranged therein for agitating and discharging toner. Another includes an auger member arranged on one of the containers inner wall for rotating it so that toner can smoothly be discharged. Another background toner container does not include any toner discharging mechanisms for supplying toner which is discharged by hand.

In recent years, toner containers have been collected and/or reused in order to avoid negatively impacting the environment. In order to encourage recycling, a flexible toner container has been proposed. The flexible toner container is formed of a flexible material, thus allowing its volume to be reduced after use. However, dry-type toners generally have low fluidity levels and high cohesiveness, thereby difficultating toner discharge. Since flexible toner containers are easily deformable, agitators or discharging mechanisms cannot easily be added thereto. If a discharging mechanism is provided to the flexible toner container, its volume reducibility deteriorates. Further, the flexible toner container cannot easily be handled to manually supply the toner.

In the light of the above-described circumstances, a technique has been proposed such that the toner contained in the flexible toner container is agitated and fluidized by supplying air to the toner and then transported and discharged by a suction type powder pump (a uniaxial contained screw pump).

A flexible toner container may also be equipped with a toner outlet arranged at its lower portion with the toner outlet facing downwardly mounted to a nozzle. To enhance toner fluidity, the shape of the flexible container is tapered toward its outlet so that the toner is conveyed to the toner outlet by its own weight. Further, a self-closing valve is provided to prevent the toner from leaking when the toner container is removed.

A toner supply system including the above-described flexible toner container can smoothly supply toner to a developing device. However, it has been found that a large amount of toner remains in the container, even after a system designed to measure the level of toner in the container reports the container being empty.

### SUMMARY OF THE INVENTION

The present invention has been made in view of the above circumstances. It is an object of the present invention to provide a novel image forming apparatus capable of efficiently replenishing toner for a soft toner container.

It is another object of the present invention to provide a novel toner supply system included in the novel image forming apparatus.

In one exemplary embodiment, a novel image forming apparatus includes a toner container, a toner transporting tube and a nozzle. The toner container includes a connecting cap having an opening which has a first lateral cross-sectional area through which the toner is discharged. The nozzle includes an inner passage having a second lateral cross-sectional area greater than sixty percent of a first lateral cross-sectional area and first and second ends arranged opposite to each other in an axial direction. The first and second ends of the nozzle have openings in communication with each other through the inner passage. The nozzle's first end is securely connected to the connecting cap of the toner container by insertion of the toner container with its connecting cap facing the nozzle's first end and a second connection between the second end of the nozzle and the toner transportation tube. The nozzle is arranged in an approximately vertical direction with the first end facing upward.

Further, in one exemplary embodiment, a novel image forming method may include the steps of: providing a toner container filled with toner, the container including a connecting cap having an opening which has a first lateral cross-sectional area through which the toner is discharged; and mounting the toner container to a nozzle, wherein the nozzle includes an inner passage having a second lateral cross-sectional area greater than sixty percent of a first lateral cross-sectional area and first and second ends arranged opposite to each other in an axial direction, the nozzle's first and second ends have openings in communication with each other through an inner passage, the first end being securely connected to the connecting cap of the toner container by insertion of the toner container with its connecting cap facing the nozzle's first end and a secured connection between the second end of the nozzle and a toner transportation tube, and the nozzle is arranged in an approximately vertical direction with the first end facing upward.

In another exemplary embodiment, another novel image forming apparatus includes an air source and a plurality of toner supplying mechanisms, each one of which includes a toner container, a toner transportation tube and a nozzle. The toner container includes a connecting cap having an opening which has a first lateral cross-sectional area through which toner is discharged. The nozzle includes an inner passage, having a second lateral cross-sectional area greater than sixty percent of the first lateral cross-sectional area, and first and second ends arranged opposite in an axial direction, wherein the first and second ends have openings in communication with each other through the inner passage, the first end is securely connected to the connecting cap of the toner container by insertion of the toner container with its connecting cap facing the nozzle's first end and a secured connection between the second end of the nozzle and the toner transportation tube, and the nozzle is arranged in an approximately vertical direction with the first end facing upward.

The above-described image forming apparatus may further include an air distributor, which has a single air inlet securely connected to the air source, and a plurality of air outlets, each securely connected to the side opening of the nozzle, the air distributor being configured to distribute air supplied by the air source.

Each of the plurality of air inlets may include an electromagnetic valve.

The toner container may include a toner bag containing the toner and a protection case configured to enclose the toner bag.

The toner bag may have a pyramid-shaped side at approximately the center of which the connecting cap is fixed.

The toner bag may be made of a flexible and recyclable material.

The protection case may be made of a foldable and recyclable material.

The connecting cap may include a seal member sealing the opening of the connecting cap to prevent toner from leaking from the toner bag when the nozzle is engaged with the connecting cap via the container's opening.

The connecting cap may further include a coil spring disposed inside the opening of the connecting cap and an inner stopper engaged with the coil spring and configured to allow a toner flow when the nozzle is not engaged and to stop the toner flow when the nozzle is engaged with the connecting cap via the opening.

The nozzle may have two channels, one of which includes an air supplying path and the other a toner conveying path surrounded by the air supplying path.

The above-described image forming apparatus may further include a powder pump connected to the toner transportation tube to pump the toner transported there through.

Toner particles of the toner may have an average degree of roundness in the range from approximately 0.96 to approximately 1.00.

Further, in one exemplary embodiment, a novel method of image forming includes the steps of: providing a toner container filled with toner, including a connecting cap having an opening with a first lateral cross-sectional area through which the toner is discharged; providing a nozzle comprising an inner passage having a second lateral cross-sectional area greater than sixty percent of the first lateral cross-sectional area and first and second ends arranged opposite in an axial direction, wherein the first and second ends have openings in communication with each other through the inner passage, the first end is securely connected to the connecting cap of the toner container by insertion of the toner container with its connecting cap facing the nozzle's first end and a secured connection between the second end of the nozzle and a toner transportation tube, and the nozzle is arranged in an approximately vertical direction with the first end facing upward, mounting the toner container to the nozzle; and sending air to the toner in the toner container through the opening of the connecting cap.

The above-described method may further include the steps of providing an air distributor having a single air inlet securely connected to the air source and a plurality of air outlets, each securely connected to the side opening of the nozzle, and distributing air supplied by the air source.

The above-described method may further include the step of sealing the opening of the connecting cap with a sealing member to prevent toner from leaking from the toner bag when the nozzle is engaged with the connecting cap via the container's opening.

The above-described method may further include the step of arranging a coil spring inside the opening of the connecting cap, engaging an inner stopper with the coil spring, activating a toner flow when the nozzle is not engaged with the toner connecting cap of the toner container; and stopping the toner flow when the nozzle is engaged with the connecting cap via the opening.

The above-described method may further include the step of connecting a powder pump to pump toner through the toner transportation tube.

In one exemplary embodiment, a novel toner supply system includes a toner container, a toner transportation tube and a nozzle. The toner container contains toner and includes a connecting cap having an opening which has a first lateral cross-sectional area and which the toner is discharged. The nozzle includes an inner passage having a second lateral cross-sectional area greater than sixty percent of the first lateral cross-sectional area and first and second ends arranged opposite in an axial direction, wherein the first and second ends have openings in communication with each other through the inner passage, the first end is securely connected to the connecting cap of the toner container by insertion of the toner container with its connecting cap facing the nozzle's first end and a second connection between the second end of the nozzle and the toner transportation tube, and the nozzle is arranged in an approximately vertical direction with the first end facing upward.

Further, in one exemplary embodiment, another novel toner supply system includes an air source and a plurality of toner supplying mechanisms. Each one of the plurality of toner supplying mechanisms includes: a toner container with a connecting cap having an opening which has a first lateral cross-sectional area through which the toner is discharged; a toner transportation tube; and a nozzle including an inner passage having a second lateral cross-sectional area greater than sixty percent of the first lateral cross-sectional area and first and second ends arranged opposite in an axial direction, wherein the first and second ends have openings in communication with each other through the inner passage, the first end is securely connected to the connecting cap of the toner container by insertion of the toner container with its connecting cap facing the nozzle's first end and a second connection between the second end of the nozzle and the toner transportation tube, and the nozzle is arranged in an approximately vertical direction with the first end facing upward.

The above-described novel toner supply system may further include an air distributor having a single air inlet securely connected to the air source and a plurality of air outlets, each securely connected to the side opening of the nozzle and configured to distribute air supplied by the air source.

The above-described novel toner supply system may further include a powder pump connected to the toner transportation tube and configured to pump toner through the toner transportation tube.

Further, in one exemplary embodiment, a novel method of toner supplying for use in an image forming system is disclosed, the method comprising: providing a toner container filled with toner; the container including a connecting cap having an opening which has a first lateral cross-sectional area and through which the toner is discharged; and connecting a nozzle to the container, the nozzle comprising an inner passage having a second lateral cross-sectional area greater than sixty percent of the first lateral cross-sectional area and first and second ends arranged opposite in an axial direction, wherein the first and second ends have openings in communication with each other through the inner passage, the first end is securely connected to the connecting cap of the toner container by insertion of the toner container with the connecting cap facing the first end and the second end being securely connected to a toner transportation tube, and the nozzle is arranged in an approximately vertical direction with the first end facing upward.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view of a structure of an image forming apparatus according to an exemplary embodiment of the present invention;

FIG. 2 is a schematic view of a structure of an exemplary toner supply system in the image forming apparatus of FIG. 1;

FIGS. 3A and 3B are schematic views of an exemplary nozzle in the toner supply system of FIG. 2;

FIG. 4 is a schematic cross-sectional view of another exemplary nozzle alternative to the nozzle of FIGS. 3A and 3B;

FIG. 5 is a cross-sectional view of a pump section of a suction pump in the toner supply system of FIG. 2;

FIG. 6 is a schematic view of an air supply device in the toner supply system of FIG. 2 that supplies air into electromagnetic valves for different colors;

FIG. 7 is a perspective view of a toner bag in the toner supply system of FIG. 2;

FIGS. 8A and 8B are schematic views of another exemplary toner container alternative to the toner container of the toner supply system of FIG. 2; and

FIG. 9 is a graph showing a relationship between the amount of toner left in the toner container and the rate of lateral cross-sectional areas of a connecting cap and a nozzle.

### DETAILED DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

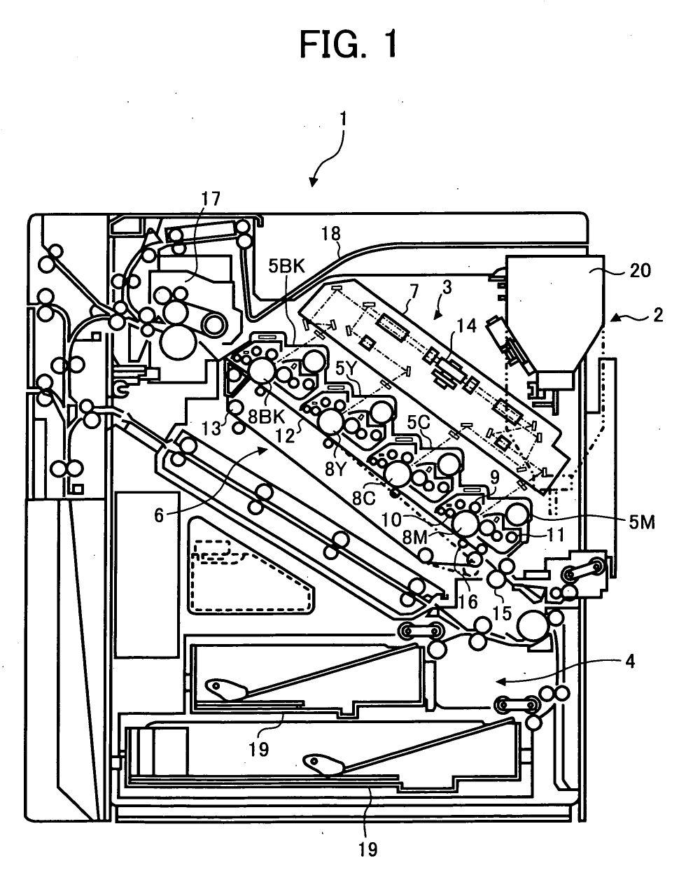

Referring now to the drawings, wherein like reference numerals designate identical or corresponding parts throughout the several views, particularly to FIG. 1, where a color laser printer 1 is shown as an example of an electrophotographic image forming apparatus that includes a toner supply system 2 according to an exemplary embodiment of the present invention.

In FIG. 1, the color laser printer 1 includes an image forming portion 3 and a sheet feeding portion 4.

The image forming portion 3 includes four image forming units 5M, 5C, 5Y and 5BK, a belt transfer system 6 and an optical writing system 7.

The four image forming units 5M, 5C, 5Y and 5BK for forming magenta (M), cyan (C), yellow (Y) and black (BK) toner images, respectively, are disposed with an angle to a horizontal plane in an obliquely downward direction from left to right of the color laser printer 1 in FIG. 1.

The four image forming units 5M, 5C, 5Y and 5BK have identical structures to each other. Each of the image forming units includes a photoconductive drum 8, a charging roller 9, a cleaning roller 10 and a developing unit 11. The photoconductive drum 8 serves as an image bearing member and is rotated by a drive unit (not shown) in a clockwise direction in FIG. 1. The charging roller 9 is applied with a charged voltage uniformly charging the photoconductive drum 8. The cleaning roller 10 removes residual toner adhering to a surface of the photoconductive drum 8. The developing unit 11 develops an image using a two-component developer and monitors a mixture ratio of the toner and carriers contained there in order to insure that the amount of toner consumed due to repeated image forming operations is replenished.

The belt transfer system 6 includes a transfer belt 12, a plurality of rollers 13 and a belt drive unit (not shown). The transfer belt 12 forms an endless belt extended with the plurality of rollers 13 and is rotated by the belt drive unit included in one of the plurality of rollers 13. The transfer belt 12 is disposed at a position over the sheet feeding portion 4 and is held in contact with the photoconductive drums 8M, 8C, 8Y and 8BK of the image forming units 5M, 5C, 5Y and 5BK, respectively. Along with the image forming units 5M, 5C, 5Y and 5BK, the transfer belt 12 is also arranged on an angle with respect to a horizontal plane in the obliquely downward direction from left to right of the color laser printer 1 in FIG. 1.

The optical writing system 7 includes a polygon mirror 14.

The sheet feeding portion 4 includes registration rollers 15, a transfer roller 16, a fixing unit 17, a discharging tray 18 and sheet feeding cassettes 19. The registration rollers 15 are a pair of rollers disposed in the vicinity of the image forming unit 5M. The transfer roller 16 is held in contact with the transfer belt 12 on a surface opposite to an area in which the photoconductive drum 8M is held in contact. The fixing unit 12 is arranged to an upper portion in the vicinity of the image forming unit 5BK.

The color laser printer 1 produces a full-color image through the following operations. As previously described, the image forming units 5M, 5C, 5Y and 5BK have identical structures. Therefore, the explanation given will focus on the operations performed by the image forming unit 5M.

The optical writing system 7 emits a laser beam to the polygon mirror 14 to irradiate a surface of the photoconductive drum 8M of the image forming unit 5M via a plurality of optical lenses including a cylinder lens and mirrors. With the above-described operation, an electrostatic latent image is formed according to an image data sent by a host machine (not shown), such as a personal computer. The surface of the photoconductive drum 8M is previously charged by the charging roller 9. An electrostatic latent image is then developed by the developing unit 11 to form a magenta toner image on the surface of the photoconductive drum 8M.

In the sheet feeding portion 4, a transfer sheet (not shown) is fed from a lower portion of the color laser printer 1 and is discharged to an upper portion thereof.

The transfer sheet is placed on the top of a stack of transfer sheets in one of the sheet feeding cassettes 19 and is conveyed to a portion between the registration rollers 15. The registration rollers 15 stop and feed the transfer sheet in synchronization with a movement of the visualized magenta toner image towards the transfer belt 12 to a transfer area which is arranged opposite to the photoconductive drum 8M. In the transfer area, the transfer roller 16 is applied with an adequate predetermined transfer voltage such that the visualized magenta toner image, formed on the surface of the photoconductive drum 8M, is transferred on the transfer sheet.

Cyan, yellow and black toner images formed by the image forming units 5C, 5Y and 5BK, respectively, are sequentially overlaid on the surface of the transfer sheet on which the magenta toner image is already formed, such that an overlaid toner image is formed on the transfer sheet when it is conveyed to each of the corresponding transfer areas by the transfer belt 12. Therefore, the color laser printer 1 processes one of the advantages of a tandem type color printer, which is that a full-color image can be produced in a short period of time.

After the overlaid toner image is formed on the transfer sheet, the transfer sheet is separated from the transfer belt 12 and is conveyed further upward to be fixed by the fixing unit 17. After the transfer sheet passes through the fixing unit 17, the transfer sheet is discharged with the surface having the image thereon facing downward to the sheet discharging portion 18 provided at the upper portion of the color laser printer 1.

The toner supply system 2, including the toner container 20, may be arranged at an upper right location of the color laser printer 1 above the optical writing device 7, as illustrated in FIG. 1. As previously described, the developing unit 11M monitors the toner-to-carrier mixture ratio in order to assure that the amount consumed is properly replaced. To supply the toner from the toner container 20 to the developing unit 11, which is separately disposed from the toner container 20, a toner supply system 2 is utilized. In FIG. 1, only one toner container 20 is illustrated. However, there are four sets of the toner containers 20 in the color laser printer 1, one for each of the developing units 11M, 11C, 11Y and 11 BK.

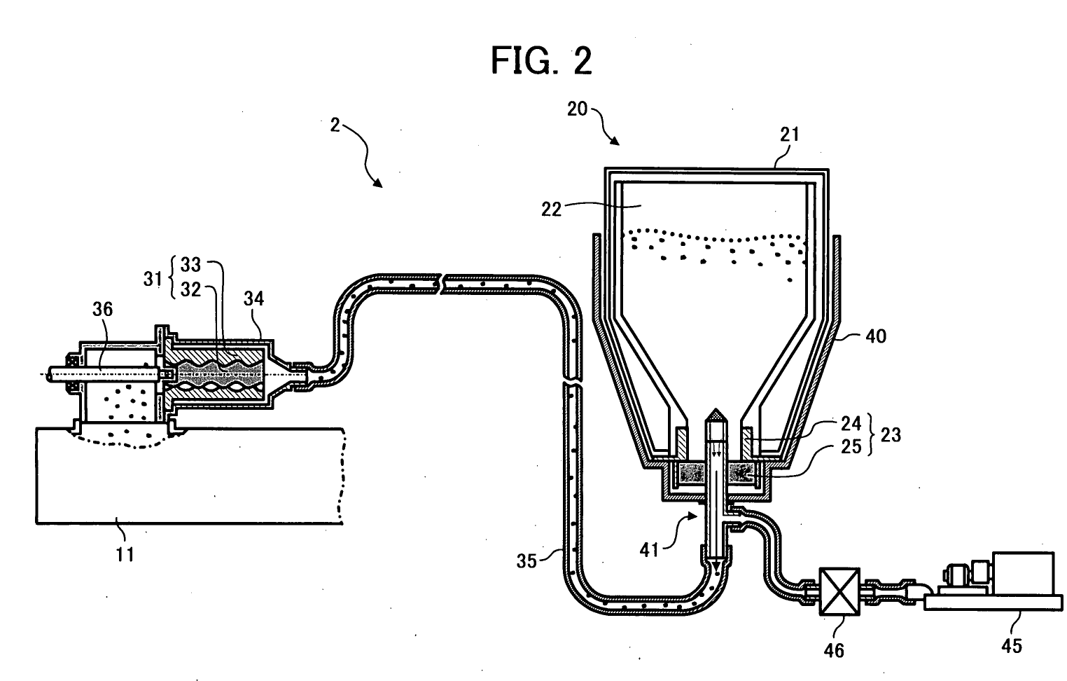

Referring to FIG. 2, a structure of the toner supply system 2, according to one exemplary embodiment of the present invention, is described.

The toner supply system 2 includes the toner container 20, a container holder 40, a powder pump 31 and an air supply device 45.

The toner container 20 has a bag-in-box type configuration including a protection case 21 and a toner bag 22.

The protection case 21 may be made of different materials, such as rigid paper, cardboard and plastic, and surrounds the flexible toner bag 22. A part of the protection case 21 is engaged with a connecting cap 23 of the toner bag 22 for discharging toner. The protection case 21 is rigid, thus enhancing operability for attaching and detaching the toner container 20 to and from the container holder 40, for example, when the toner container 20 is replaced with a new one. Further, the toner in the toner container 20 is protected from environmental conditions by the protection case 21, thereby maintaining toner quality in the toner container 20.

The toner bag 22 may be formed from resin materials, such as polyethylene and nylon or flexible sheet materials, having a thickness from approximately 80 μm to approximately 200 μm. The toner bag 22 may have a single or multiple layer construction, and is kept in an airtight condition. The toner bag 22 includes the connecting cap 23 for discharging toner.

The connecting cap 23 is engaged with the protection case 21 at an engaging portion so that the toner container 20 can be mounted securely to the container holder 40. The connecting cap 23 includes a case 24 and a seal member 25.

The case 24 is formed from resin materials, such as polyethylene and nylon. If the case 24 is formed from the same material as the toner bag 22, it is advantageous for recycling, and the case 24 may be easily adhered to the toner bag 22.

The seal member 25 may be formed from an elastic body, such as a foaming sponge and a rubber material, having the same resistance quality as the toner, little air penetration, and superior strength for creep. The seal member 25 includes a cross-shaped slit. When a nozzle 41 is inserted into the seal member 25 of the connecting cap 23, the seal member 25 is intimately held in contact with the nozzle 41, thereby preventing a toner leak from the toner container 20. Further, when the toner container 20 is detached from the container holder 40, the cross-shaped slit of the seal member 25 is closed due to its elasticity, thereby preventing a toner leak from the toner container 20. A length of the cross-shaped slit of the seal member 25 is substantially equal to or greater than an outer diameter of the nozzle 41 by approximately 3 mm. The seal member 25 and the case 24 may be joined together by a double-faced adhesive tape.

As illustrated in FIG. 2, the toner container 20 is loaded into the container holder 40 from above the color laser printer 1. The nozzle 41 in the container holder 40 has a round-shaped lateral cross-sectional area and extends upright so as to be engaged with the connecting cap 23, penetrating into the toner container 20.

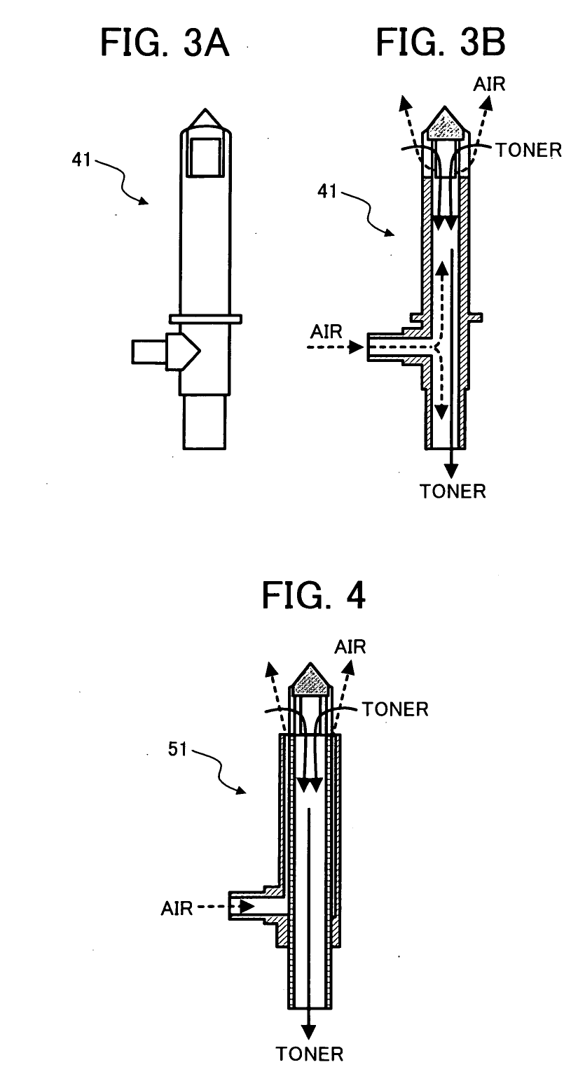

Referring now to FIGS. 3A, 3B and 4, structures of various nozzles, including the nozzle 41, are described. As illustrated in FIGS. 3A and 3B, an air supplying path merges with a toner conveying path in the nozzle 41. Instead of the nozzle 41 illustrated in FIG. 3, a nozzle having an alternative structure may be used. As illustrated in FIG. 4, a nozzle 51 may have a double wall structure including an outer air supplying path flowing coaxially with an inner toner conveying path. The toner supply system 2 illustrated in FIG. 2 uses the nozzle 41 illustrated in FIGS. 3A and 3B in view of its lower cost compared to the nozzle 51 illustrated in FIG. 4.

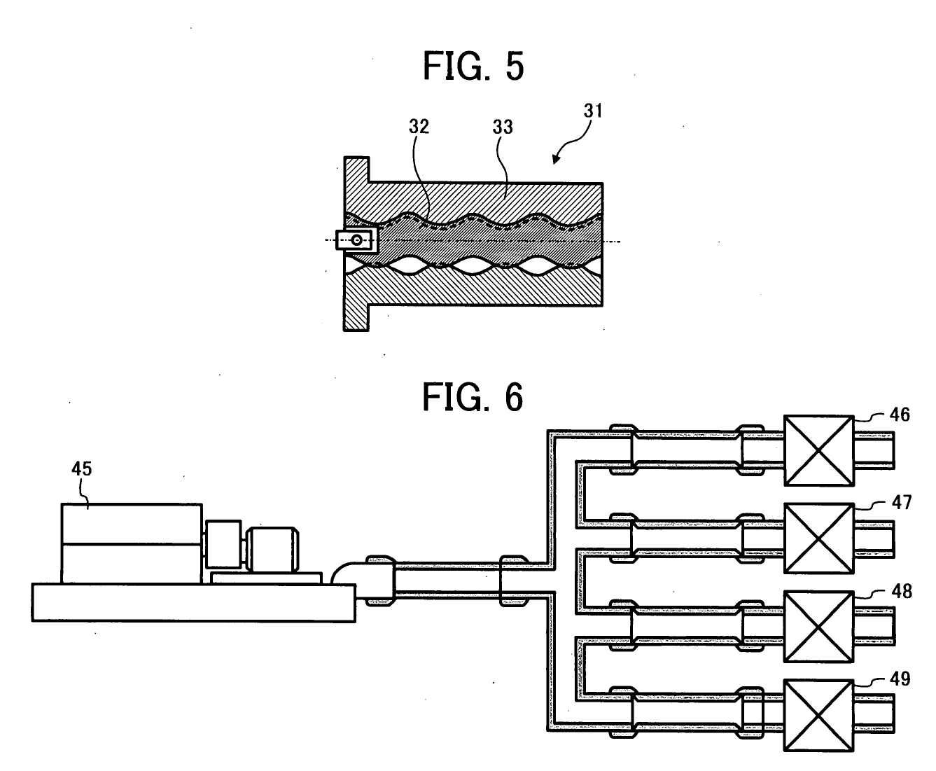

Referring to FIG. 2 again, a structure of the powder pump 31 is described. The powder pump 31 is activated for supplying toner to the developing unit 11. The powder pump 31 uses, for example, a suction type uniaxial eccentric screw pump, which is referred to as a Moineau-pump. The powder pump 31 includes a rotor 32, a stator 33, a holder 34 and a driving shaft 36. The rotor 32 is formed from a rigid material, such as metal, and is formed into a shape of an eccentric wavy screw, as illustrated in FIG. 5. The stator 33 is formed from an elastic material, such as rubber, surrounding the rotor 32. On the internal circumferential surface of the stator 33 a spiral groove is formed having two stripes. As illustrated in FIG. 2, the holder 34 holds the rotor 32 and the stator 33 and may be formed from resin materials for forming a powder conveying path. The driving shaft 36 is engaged with the rotor 32, extending to the developing unit 11. The driving shaft 36 rotates the rotor 32 for driving the powder pump 31 to pump toner.

When the driving shaft 36 rotates the rotor 32, a strong suction pressure is generated in the powder pump 31. With the suction pressure, the powder pump 31 transports toner from the toner container 20 through a flexible tube 35 which may be referred to as a toner transportation tube.

The flexible tube 35 is a toner conveying tube connecting the powder pump 31 to the toner container 20 of FIG. 2. The flexible tube 35 is formed from rubber materials and plastic materials which are superior in flexibility and toner resistance property. Examples of the rubber materials include polyurethane, nitrile, EPDM, silicone, and others. Examples of the plastic materials include polyethylene, nylon, and other similar plastics. The tube 35 has an inner diameter ranging from approximately 4 mm to approximately 10 mm.

The toner is discharged from the toner container 20 not only by the suction pressure generated by the powder pump 31, but also by its own weight as seen from FIG. 2. Generally, electrophotographic image toners do not flow smoothly. Therefore, toner supplied to the developing device 11 by use of the powder pump 31 may experience the so-called toner bridge phenomenon, which may occur in the toner container 20 after the toner in the vicinity of the nozzle 41 attached to the lower portion of the toner container 20 is removed from the container. The toner bridge phenomenon is when a limited portion of toner positioned above a toner outlet is discharged, forming a void around the outlet of the toner container 20. As a result, the toner is not smoothly conveyed from the toner container 20 to the developing device 11, causing undesirable instability on the amount of toner supplied to the developing device 11 and relatively large amounts of toner to be left in the toner container 20.

To avoid the above-described problem, an air supply device 45 is attached to the toner container 20, in addition to the powder pump 31. The air supply device 45 supplies air into the toner container 20 through an electromagnetic valve 46 and the nozzle 41.

Referring to FIG. 6, the air supply device 45 in a multi-color image forming apparatus is shown. As illustrated in FIG. 6, in the air supply device 45 the air supply is divided by electromagnetic valves 46 through 49 for respective colors. Air is preferably supplied to the toner container 20 for five seconds or less in view of a clog that may be formed due to excessive air. Even in a multi-color image forming apparatus such as a four color image forming apparatus, air may be supplied from a single air supply device such as the air supply device 45. The air supply device 45 is a commonly known air pump capable of supplying air at a flow rates from approximately 1 to 3 liters per minute.

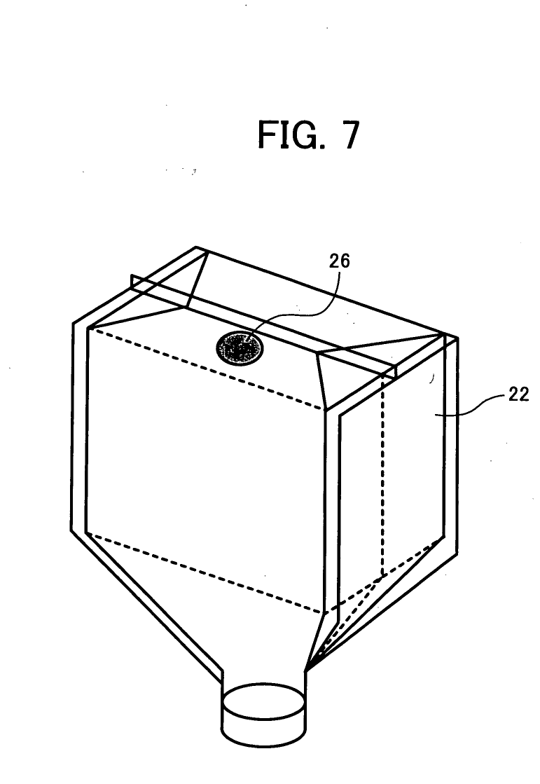

Referring to FIG. 7, the toner bag 22 having an airflow filter 26 is described. As illustrated in FIG. 7, the airflow filter 26 may be provided at the top surface of the toner bag 22. With the airflow filter 26, an excess air pressure in the toner bag 22 generated by the air supplied from the air supply device 45 can be prevented.

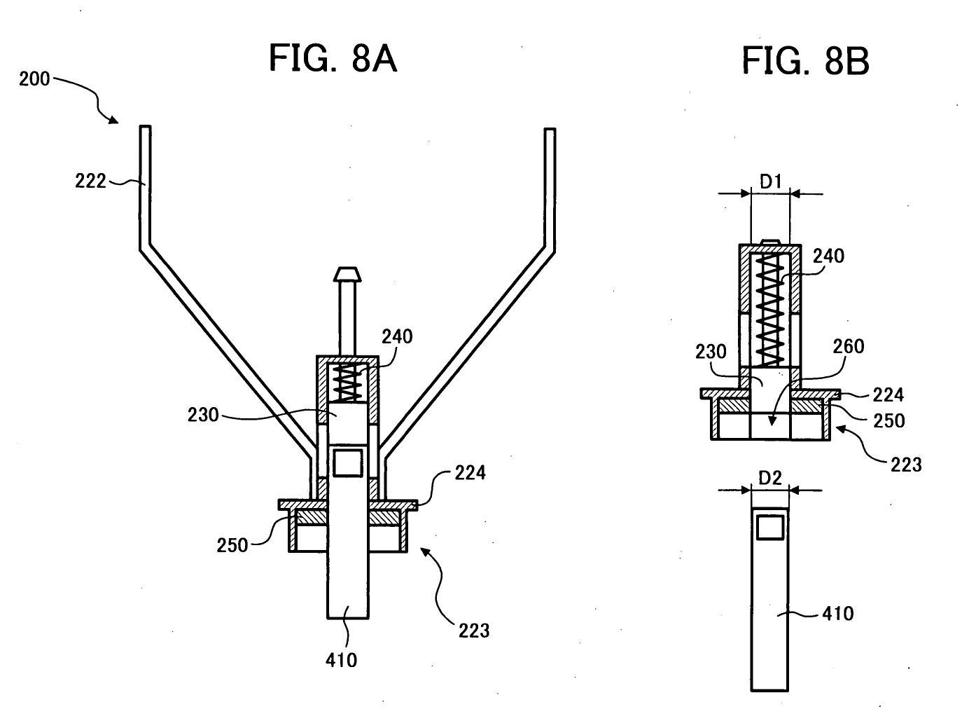

Referring to FIGS. 8A and 8B, another exemplary toner container 200 alternative to the toner container 20 of the toner supply system 2 according to the present invention is described. Instead of the seal member 25 of the toner container 20 of FIG. 2, the toner container 200 includes a shutter mechanism to keep the container closed using an inner stopper 230 and a coil spring 240. When the nozzle 410 is inserted into the toner container 200, as illustrated in FIG. 8A, the inner stopper 230 is pressed by a tip portion of the nozzle 410 and moves up against an elastic force generated by the coil spring 240, opening the container. When the nozzle 410 is pulled out of the toner container 200, as illustrated in FIG. 8B, the coil spring 240 pushes the inner stopper 230 back to the closed position. A connecting cap 223 of the container 200, comprising a case 224 and a seal member 250, has a circular opening 260 at the center of the seal member 250. The case 224 guides the movement of the inner stopper 230 and the seal member 250 seals the opening 260 of the toner container 200 with the inner stopper 230 at the closed position. The inner passage extends throughout the opening 260 having a circular cross-section corresponding to a contour of the nozzle 410.

An opening of the toner container 200 has a lateral cross-sectional area equal to that of the inner stopper 230 based on a diameter D1 of the inner passage of the toner container 200. The nozzle 410 also has a lateral cross-sectional area based on a diameter D2 of the nozzle 410. In the toner container 200 illustrated in FIGS. 8A and 8B, a lateral cross-sectional area of the inner stopper 230 is made the same as that of the inner passage of the toner container 200.

Further, tests have been conducted to examine the effect of the ratio of a lateral cross-sectional area of an opening of a connecting cap of a toner container to the lateral cross-sectional area of the nozzle on the amount of toner remaining in a toner container after toner supplying operations.

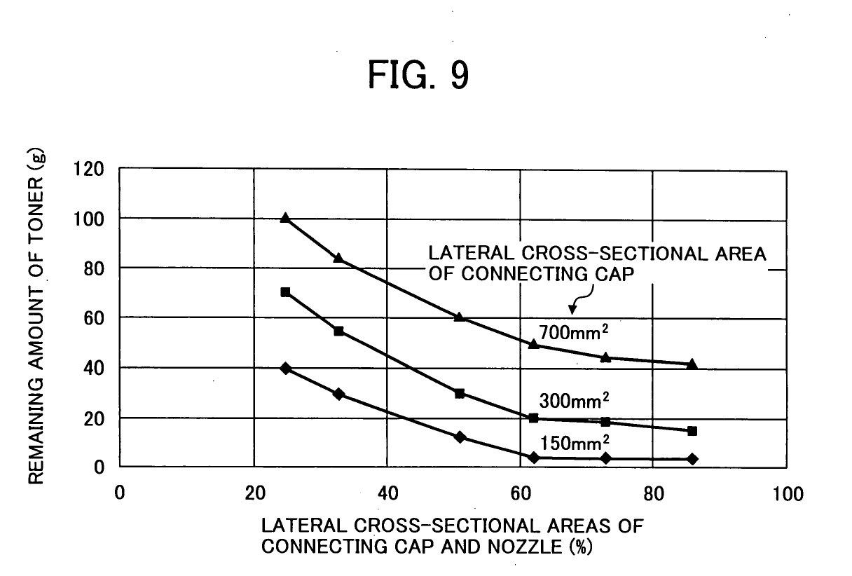

Referring to FIG. 9, a graph of the results of the above-mentioned tests is shown for three different cross-sectional areas of connecting caps. In the test, connecting caps having a lateral cross-sectional areas of 700, 300, and 150 mm² were used for toner containers containing a very large amount, a regular amount of toner, and a small amount of toner, respectively.

As illustrated in the graph of FIG. 9, a cross-section ratio of 100% is most preferable for the nozzle with respect to the engaging portion of the connecting cap. It has also been found that a cross-section ratio equal to or greater than 60% is preferable. If the cross-section ratio of the nozzle with respect to the engaging portion of the connecting cap is less than 60%, a toner bag is deformed because of the weight of toner accumulated on a portion between the connecting cap and the nozzle. That is, a taper angle of the flexible toner container increases, preventing a large amount of toner to reach the toner outlet of the nozzle.

In order to prevent a large portion of unused toner to remain in the toner container when the toner end is detected, the roundness of a toner particle is preferably in the range from approximately 0.96 to approximately 1.00, for example. Examples of toner particle having such roundness are polymerized toner particles instead of pulverized toner particles.

After the toner in the toner container 20 is consumed, the toner container 20 is easily split into the protection case 21 and the toner bag 22. Because the protection case 21 is foldable and the toner bag 22 is flexible, as compared to conventional hard toner cartridges and bottles, the toner container 20 has several advantages including, but not limited to, an easy handling compact size, during transportation and storage, and savings in storage space. Therefore, the distribution cost for collecting toner containers from a user to a manufacturer can be greatly reduced.

For driving and controlling the toner supply system 2 according to the embodiment of the present invention, a commonly used method of detecting and controlling developer densities can be employed. A detector (not shown) detecting a ratio of magnetic flux density to magnetic field is provided to the developing unit 11 of the color laser printer 1 so that variations of the mixture ratio of the toner and carriers in the developing unit 11 are detected. When a detection result shows “Running out of toner”, the driving shaft 36 is rotated to activate the powder pump 31 to supply toner from the toner bag to the developing unit 11. When a predetermined amount of toner is conveyed to the developing unit 11, the detector issues a signal for stopping the rotation of the driving shaft 36 of the powder pump 31. As an alternative, a commonly used technique may be used. For example, a reflection density of a toner image formed on a photoconductive element is detected to control the amount of toner supplied for forming the toner image.

Although the present invention has been described with reference to preferred embodiments, the present invention is also applied to a black-and-white printer.

Numerous additional modifications and variations are possible in light of the above teachings. It is therefore to be understood that within the scope of the appended claims, the disclosure of this patent specification may be practiced otherwise than as specifically described herein.

1. An image forming apparatus, comprising:
a toner container having a connecting cap with an opening having a lateral cross-sectional area through which a toner is discharged;
a toner transportation tube; and
a nozzle comprising an inner passage, and first and second ends arranged opposite in an axial direction, the first and second ends having openings in communication with each other through the inner passage, the first end being connected to the connecting cap and the second end being connected to the toner transportation tube, wherein the nozzle is arranged approximately in a vertical direction with the first end facing upward, and a lateral cross-sectional area of the nozzle is greater than sixty percent of the cross-sectional area of the opening.

2. An image forming apparatus, comprising:
containing means for containing toner, the containing means comprising a connecting cap with an opening having a lateral cross-sectional area through which the toner is discharged;
transporting means for transporting the toner; and
a nozzle comprising an inner passage, and first and second ends arranged opposite in an axial direction, the first and second ends having openings in communication with each other through the inner passage, the first end being connected to the connecting cap and the second end being connected to the transporting means, wherein the nozzle is arranged approximately in a vertical direction with the first end facing upward, and a lateral cross-sectional area of the nozzle is greater than sixty percent of the cross-sectional area of the opening.

3. A method of image forming, comprising:
providing a toner container having a connecting cap with an opening having a first lateral cross-sectional area through which a toner is discharged;
providing a nozzle comprising an inner passage, and first and second ends arranged opposite in an axial direction, the first and second ends having openings in communication with each other through the inner passage, the first end being connected to the connecting cap and the second end being connected to a toner transportation tube, wherein the nozzle is arranged approximately in a vertical direction with the first end facing upward, and a lateral cross-sectional area of the nozzle is greater than sixty percent of the cross-sectional area of the opening; and
mounting the toner container to the nozzle.

4. An image forming apparatus, comprising:
an air source; and
a toner supplying mechanism, comprising:
a toner container having a connecting cap with an opening having a lateral cross-sectional area through which a toner is discharged;
a toner transportation tube; and
a nozzle comprising an inner passage, and first and second ends arranged opposite in an axial direction, the first and second ends having openings in communication with each other through the inner passage, the first end being connected to the connecting cap and the second end being connected to the toner transportation tube, wherein the nozzle is arranged approximately in a vertical direction with the first end facing upward, and a lateral cross-sectional area of the nozzle is greater than sixty percent of the cross-sectional area of the opening.

5. The image forming apparatus according to claim 4, further comprising:
an air distributor having an air inlet connected to the air source and an air outlets connected to a side opening of the nozzle.

6. The image forming apparatus according to claim 5, wherein the air inlet further comprises an electromagnetic valve.

7. The image forming apparatus according to claim 4, wherein the toner container comprises:
a toner bag; and
a protection case configured to enclose the toner bag.

8. The image forming apparatus according to claim 7, wherein the toner bag has a pyramid-shaped side at an approximately center of which the connecting cap is fixed.

9. The image forming apparatus according to claim 7, wherein the toner bag is made of a flexible material.

10. The image forming apparatus according to claim 7, wherein the protection case is made of a foldable material.

11. The image forming apparatus according to claim 7, wherein the connecting cap further comprises:
a seal member positioned at the opening of the connecting, the seal member being configured to prevent a toner leak from the toner bag when the nozzle is engaged with the connecting cap of the toner container via the opening.

12. The image forming apparatus according to claim 11, wherein the connecting cap further comprises:
a coil spring disposed inside the opening of the connecting cap; and
an inner stopper engaged with the coil spring, the inner stopper being configured to prevent toner to flow out of the toner container when the nozzle is not engaged with the toner connecting cap and to allow toner to flow when the nozzle is engaged with the connecting cap via the opening.

13. The image forming apparatus according to claim 4, wherein the nozzle further comprises an outer channel concentric to an inner channel, the outer channel providing an air supplying path and the inner channel providing a toner conveying path.

14. The image forming apparatus according to claim 4, further comprising:
a powder pump to pump toner through the toner transportation tube.

15. The image forming apparatus according to claim 4, wherein toner particles have an average degree of roundness in a range from approximately 0.96 to approximately 1.00.

16. An image forming apparatus, comprising:
supplying means for supplying air; and
a plurality of toner supplying mechanisms, each toner supplying mechanism of said plurality comprising:
containing means for containing toner,
transporting means for transporting the toner from the containing means; and
nozzling means for facilitating a transport of the toner from inside said containing means to said transporting means using said supplying means.

17. The image forming apparatus according to claim 16, further comprising:
distributing means for distributing air supplied by the supplying means to each nozzling means in the plurality of toner supplying mechanism.

18. The image forming apparatus according to claim 17, wherein said distributing means further comprises an electromagnetic valve.

19. The image forming apparatus according to claim 16, wherein the containing means comprises:
accommodating means for containing the toner; and
enclosing means for enclosing the accommodating means.

20. The image forming apparatus according to claim 19, wherein the accommodating means is made of a flexible material.

21. The image forming apparatus according to claim 19, wherein the accommodating means is made of a flexible material.

22. The image forming apparatus according to claim 19, wherein the enclosing means is made of a foldable and recyclable material.

23. The image forming apparatus according to claim 19, wherein the containing means further comprises sealing means for preventing a toner leak from the accommodating means when connecting the nozzling means with the containing means.

24. The image forming apparatus according to claim 23, wherein the containing means further comprises biasing means for biasing a position of stopping means disposed inside the containing means, wherein a function of said stopping means is to prevent a toner flow when the nozzling means is not connected with the containing means and to allow the toner flow when the nozzling means is connected with the connecting means.

25. The image forming apparatus according to claim 16, wherein the nozzling means further comprises: air channeling means for channeling air from the supplying means to the containing means; and toner channeling means for channeling toner from the containing means to the transporting means.

26. The image forming apparatus according to claim 16, further comprising:
pumping means for pumping toner from the containing means through the transporting means.

27. The image forming apparatus according to claim 16, wherein toner particles have an average degree of roundness in a range from approximately 0.96 to approximately 1.00.

28. A method of image forming, comprising:
providing a toner container filled with toner, the toner container comprising a connecting cap with an opening having a lateral cross-sectional area through which the toner is discharged;
providing a nozzle, the nozzle comprising an inner passage, and first and second ends arranged opposite in an axial direction, the first and second ends having openings in communication with each other through the inner passage, the first end being connected to the connecting cap and the second end being connected to a toner transportation tube, wherein the nozzle is arranged approximately in a vertical direction with the first end facing upward, and a lateral cross-sectional area of the nozzle is greater than sixty percent of the cross-sectional area of the opening; and
mounting the toner container to the nozzle; and
providing an air flow to the toner contained in the toner container through the opening of the connecting cap.

29. The method of image forming according to claim 28, further comprising:
providing an air distributor having an air inlet connected to an air source supplying the air flow and an air outlet connected to a side opening of the nozzle.

30. The method of image forming according to claim 29, wherein the air inlet further comprises an electromagnetic valve.

31. The method of image forming according to claim 28, wherein the toner container further comprises:
a toner bag; and
a protection case for enclosing the toner bag.

32. The method of image forming according to claim 31, wherein the toner bag has a pyramid-shaped side at an approximately center of which the connecting cap is fixed.

33. The method of image forming according to claim 31, wherein the toner bag is made of a flexible and recyclable material.

34. The method of image forming according to claim 31, wherein the protection case is made of a foldable and recyclable material.

35. The method of image forming according to claim 31, further comprising:
sealing the opening of the connecting cap with a sealing member to prevent a toner leak from the toner bag when the nozzle is engaged with the connecting cap of the toner container via the opening.

36. The method of image forming according to claim 35, further comprising:
providing a coil spring inside the opening of the connecting cap;
engaging an inner stopper with the coil spring;
preventing a toner flow when the nozzle is not engaged with the toner connecting cap; and
stopping the toner flow when the nozzle is engaged with the connecting cap via the opening.

37. The method of image forming according to claim 28, wherein the nozzle further comprises an outer channel concentric to an inner channel, the outer channel providing an air supplying path and the inner channel providing a toner conveying path.

38. The method of image forming according to claim 28, further comprising:
connecting a powder pump to pump toner through to the toner transportation tube.

39. The method of image forming according to claim 28, wherein toner particles have an average degree of roundness in a range from approximately 0.96 to approximately 1.00.

40. A toner supply system, comprising:
a toner container having a connecting cap with an opening having a lateral cross-sectional area through which a toner is discharged;
a toner transportation tube; and
a nozzle comprising an inner passage, and first and second ends arranged opposite in an axial direction, the first and second ends having openings in communication with each other through the inner passage, the first end being connected to the connecting cap and the second end being connected to the toner transportation tube, wherein the nozzle is arranged approximately in a vertical direction with the first end facing upward, and a lateral cross-sectional area of the nozzles greater than sixty percent of the cross-sectional area of the opening.

41. A toner supply system, comprising:
containing means for containing toner;
transporting means for transporting the toner; and
nozzling means for facilitating a transport of the toner from inside said containing means to said transporting means using said supplying means.

42. A toner supply system, comprising:
an air source; and
a toner supplying mechanism, comprising:
a toner container having a connecting cap with an opening having a lateral cross-sectional area through which a toner is discharged;
a toner transportation tube; and
a nozzle comprising an inner passage, and first and second ends arranged opposite in an axial direction, the first and second ends having openings in communication with each other through the inner passage, the first end being connected to the connecting cap and the second end being connected to the toner transportation tube, wherein the nozzle is arranged approximately in a vertical direction with the first end facing upward, and a lateral cross-sectional area of the nozzle is greater than sixty percent of the cross-sectional area of the opening.

43. The toner supply system according to claim 42, further comprising:
an air distributor having an air inlet connected to the air source and an air outlet connected to a side opening of the nozzle.

44. The toner supply system according to claim 43, wherein the air inlet further comprises an electromagnetic valve.

45. The toner supply system according to claim 42, wherein the toner container comprises:
a toner bag; and
a protection case configured to enclose the toner bag.

46. The toner supply system according to claim 45, wherein the toner bag has a pyramid-shaped side at an approximately center of which the connecting cap is fixed.

47. The toner supply system according to claim 45, wherein the toner bag is made of a flexible material.

48. The toner supply system according to claim 47, wherein the protection case is made of a foldable material.

49. The toner supply system according to claim 45, wherein the connecting cap further comprises:
a seal member positioned at the opening of the connecting cap, the seal member being configured to prevent a toner leak from the toner bag when the nozzle is engaged with the connecting cap of the toner container via the opening.

50. The toner supply system according to claim 49, wherein the toner connecting cap further comprises:
a coil spring disposed inside the opening of the connecting cap; and
an inner stopper engaged with the coil spring, the inner stopper being configured to prevent toner to flow out of the toner container when the nozzle is not engaged with the toner connecting cap and to allow toner to flow when the nozzle is engaged with the connecting cap via the opening.

51. The toner supply system according to claim 42, wherein the nozzle further comprises an outer channel concentric to an inner channel, the outer channel providing an air supplying path and the inner channel providing a toner conveying path.

52. The toner supply system according to claim 42, further comprising:
a powder pump to pump toner through the toner transportation tube.

53. The toner supply system according to claim 42, wherein toner particles have an average degree of roundness in a range from approximately 0.96 to approximately 1.00.

54. A toner supply system, comprising:
supplying means for supplying air; and
a plurality of toner supplying mechanisms, each toner supplying mechanism of said plurality comprising:
containing means for containing toner,
transporting means for transporting the toner from the containing means; and
nozzling means for facilitating a transport of the toner from inside said containing means to said transporting means using said supplying means.

55. The toner supply system according to claim 54, further comprising:
distributing means for distributing air supplied by the supplying means to each nozzling means in the plurality of toner supplying mechanism.

56. The toner supply system according to claim 55, wherein said distributing means further comprises an electromagnetic valve.

57. The toner supply system according to claim 54, wherein the containing means comprises:
accommodating means for containing the toner; and
enclosing means for enclosing the accommodating means.

58. The toner supply system according to claim 57, wherein the accommodating means is made of a flexible material.

59. The toner supply system according to claim 57, wherein the accommodating means is made of a recyclable material.

60. The toner supply system according to claim 57, wherein the enclosing means is made of a foldable and recyclable material.

61. The toner supply system according to claim 57, wherein the containing means further comprises sealing means for preventing a toner leak from the accommodating means when connecting the nozzling means with the the containing means.

62. The toner supply system according to claim 61, wherein the containing means further comprises biasing means for biasing a position of stopping means disposed inside the containing means, wherein a function of said stopping means is to prevent a toner flow when the nozzling means is not connected with the containing means and to allow the toner flow when the nozzling means is connected with the connecting means.

63. The toner supply system according to claim 54, wherein the nozzling means further comprises: air channeling means for channeling air from the supplying means to the containing means; and toner channeling means for channeling toner from the containing means to the transporting means.

64. The toner supply system according to claim 54, further comprising:
pumping means for pumping toner from the containing means through the transporting means.

65. The toner supply system according to claim 54, wherein toner particles have an average degree of roundness in a range from approximately 0.96 to approximately 1.00.

66. A method of supplying toner for use in an image forming system, the method comprising:
providing a toner container filled with toner, the toner container comprising a connecting cap with an opening having a lateral cross-sectional area through which the toner is discharged;
providing a nozzle, the nozzle comprising an inner passage, and first and second ends arranged opposite in an axial direction, the first and second ends having openings in communication with each other through the inner passage, the first end being connected to the connecting cap and the second end being connected to a toner transportation tube, wherein the nozzle is arranged approximately in a vertical direction with the first end facing upward, and a lateral cross-sectional area of the nozzle is greater than sixty percent of the cross-sectional area of the opening; and
mounting the toner container to the nozzle.

67. The image forming apparatus according to claim 5, wherein the air distributor further comprises a plurality of air inlets.

68. The image forming apparatus according to claim 67, wherein each of the outlets have electromagnetic valves connected thereto.

69. The image forming apparatus according to claim 9, wherein the toner bag is made of a recyclable material.

70. The image forming apparatus according to claim 10, wherein the protection case is made of a recyclable material.

71. The toner supply system according to claim 47, wherein the toner bag is made of a recyclable material.

72. The toner supply system according to claim 48, wherein the protection case is made of a recyclable material.
